(19) United States
(12) Patent Application Publication
(10) Pub. No.: US 2019/0380307 A1
(43) Pub. Date: Dec. 19, 2019

(54) WHISTLE APPARATUS

(71) Applicant: Bark & Co., New York, NY (US)

(72) Inventors: Robert Sayegh, JR., New York, NY (US); Scott Powell, Portland, OR (US); Doug Hepler, West Henrietta, NY (US)

(73) Assignee: Bark & Co., New York, NY (US)

(21) Appl. No.: 16/445,844

(22) Filed: Jun. 19, 2019

Related U.S. Application Data
(60) Provisional application No. 62/686,900, filed on Jun. 19, 2018.

(51) Int. Cl. A01K 15/02; A63H 5/00

(52) U.S. Cl. CPC A01K 15/026; A63H 5/00

(57) ABSTRACT

In an embodiment, a whistle apparatus includes an edible whistle component and an aperture and a compressible body containing a receptacle configured to receive the edible whistle component, the receptacle portion including a passage. When an edible whistle component is secured to the receptacle of the compressible body and when the compressible body is compressed, gas is urged through both the aperture and the passage to emit a sound.

### CROSS-REFERENCE TO RELATED APPLICATION

This application claims the benefit of U.S. Provisional Application No. 62/686900 filed on Jun. 19, 2018, the recitations of which are incorporated by reference in their entirety.

### BACKGROUND

### Technical Field

The present invention relates generally to the field of pet toys, and in particular, to a whistle apparatus designed to attract and hold the attention of animals by emitting a sound via an edible whistle.

### Discussion Of The Art

The following background information may present examples of specific aspects of the prior art that, while expected to be helpful to further educate the reader as to additional aspects of the prior art, is not to be construed as limiting the present invention, or any embodiments thereof, to anything stated or implied therein or inferred thereupon.

Chew toys that emit a squeak or whistle sounds are commonplace amongst animal aficionados. The sound produced by these toys is often produced as a result of the animal chewing or otherwise compressing an air reservoir, causing the propulsion of air through an orifice containing a reed or other vibrating structure.

Although such toys such are popular among animal owners, they may be damaged beyond repair during the course of normal play. In particular, the animal may specifically focus their chewing on the whistle itself in an attempt to remove the whistle portion from the toy. This damage can include fragmentation of both the toy and squeak/whistle components, destroying the toy's functionality. As a result, there is need for a toy that contains a whistle that, upon failure due to destructive chewing, may be replaced. Moreover, there is a need for an edible whistle component, to eliminate fragmentation of the whistle and/or toy.

### BRIEF SUMMARY OF THE INVENTION

In an embodiment a whistle apparatus includes an edible whistle component having an aperture, and a compressible body containing a receptacle configured to receive the edible whistle component, the receptacle portion having a passage. When an edible whistle component is secured to the receptacle of the compressible body and when the compressible body is compressed, gas/air is urged through both the aperture and the passage to emit a sound.

In another embodiment, a whistle apparatus includes an edible whistle component having an aperture that extends therethrough and a compressible body having a substantially hollow interior, the compressible body containing a receptacle configured to selectively receive the edible whistle component, the receptacle including a flange that at least partially surrounds the receptacle to secure the edible whistle component therein, the receptacle further including a passage into the substantially hollow interior. When an edible whistle component is secured in the receptacle of the compressible body and the compressible body is compressed, gas is urged from the substantially hollow interior through both the aperture and the passage to emit a sound.

In yet another embodiment, an edible whistle component for use in a whistle apparatus includes two opposing surfaces and an aperture that extends between the surfaces, the surfaces each have a concave profile.

### BRIEF DESCRIPTION OF THE DRAWINGS

FIG. 1 is a perspective view of an embodiment of a whistle apparatus, depicted an edible whistle component and compressible body thereof, according to an embodiment of the invention.

FIG. 2 is a detail view of an embodiment of a receptacle located on the compressible body of FIG. 1.

FIG. 3 is a cross-sectional view of an embodiment of the edible whistle component and compressible body of FIG. 1 joined together.

FIGS. 4A-4B depicts a whistle apparatus according to alternative embodiment of the present invention.

FIGS. 5A-5E depict various alternative embodiments of the inventive whistle apparatus.

FIG. 6 is a perspective view of a whistle component, according to an alternative embodiment of the invention.

FIG. 7 is a cross-sectional view of a compressible body, according to an alternative embodiment of the invention.

FIG. 8A-8C are various perspective views of another embodiment of the invention.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any embodiment described herein as “exemplary” or “illustrative” is not necessarily to be construed as preferred or advantageous over other embodiments. All of the embodiments described below are exemplary embodiments provided to enable persons skilled in the art to make or use the embodiments of the disclosure and are not intended to limit the scope of the disclosure, which is defined by the claims.

It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Within this application the term “target animal species” refers to the classes of animals responsive to sound stimulation for the purposes of play or training and contemplates that different auditory capacities of the considered creatures including humans. By way of non-limiting example and without limitation to any specific theory of animal behavior, it is contemplated that the auditory stimulation needs of a human toddler or chimpanzee at play differ from those of a dog, ferret, bird, dolphin or human. Thus, the term “sound” as used herein contemplates both the frequency spectrum and amplitude of the waves emitted by the whistle and does not limit the sound to those frequencies audible to human hearing solely. Thus, the sound emitted by a whistle targeted for canine play or training may be inaudible to human hearing and a sound targeted to a human child may be unpleasant to a ferret.

The term “edible whistle component” refers to an element that is composed of materials capable of ingestion or biodegradation. Likewise the term “edible glue” refers to a material capable of performing the function of joining the edible whistle component to another element while remaining ingestible or biodegradable. Illustrative examples may be composed of materials not traditionally considered as glues such as: jams, jellies, honey, molasses, protein slurry, gluten, and other organic compounds whether wet, or dehydrated that complete the joining function. Similarly, the terms “compressed ingredients” or “solidified ingredients” refer to edible or biodegradable materials that may be compressed or solidified to form the material bulk of the edible whistle component. By way of non-limiting example, compressed materials may include grains or cereals or processed animal byproducts. Solidified materials may include various sugar solutions, rendered fats, or other edible or biodegradable material. The materials may be tailored to form specific flavors or compositions suitable for different target animal species.

Moreover, the “edible whistle component” is not limited to generating a “whistle” per se, but may emit a variety of sounds/noises, including, but not limited to, squeaks, chirps, whistles and all other possibly sounds/noises, regardless of pitch, loudness, timbre, duration, or frequency.

The term “compressible body” refers to an element that may be composed of any suitable material, geometry, or combination thereof that allows for the element to compress when force is applied.

The term “receptacle” is used in conjunction with the compressible body to designate a specialized area of the compressible body capable of receiving the edible whistle component. The receptacle may or may not include additional features designed to enhance the retention of the edible whistle component, such as interlocking geometry, and it may be integrated into the compressible body or it may be otherwise attached.

The terms “aperture” and “passage” are used synonymously to designate the same elements performing a similar function on different components: openings that allow for the movement of material from one side of a component to another; for example, air moving from the interior of a hollow chamber to the exterior. The aperture or passage orifices on both ends may be circular or of variable geometry, it is expressly contemplated that various shapes or combinations thereof may affect overall quality and tone of the sound emitted by the whistle. Thus, though the illustrative examples demonstrate passages or apertures with overall circular geometry, they may take on different forms in order to alter whistle tone and amplitude. By way of non-limiting example, one orifice of an aperture may be substantially narrower and rectangular in shape while the orifice on the opposite side of the aperture/passage.

Finally, the term “toy” as used herein not only contemplates those items used for playful purposes but also expressly does not exclude other uses such as therapeutic, comfort, training, etc.

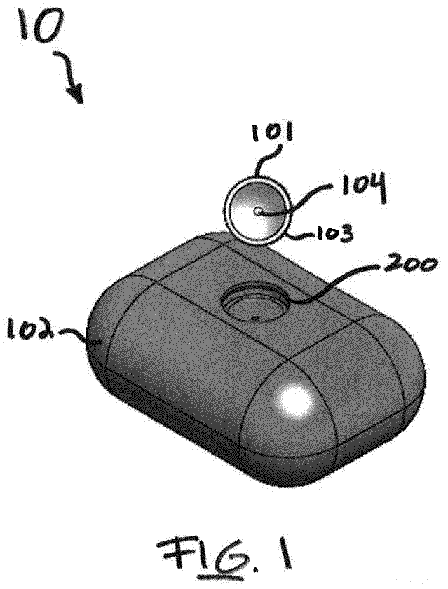

The present invention will now be described in conjunction with the drawings beginning with FIG. 1 which contains a perspective view of an embodiment of a whistle apparatus 10. As shown, the apparatus 10 includes an edible whistle component 101 and a compressible body 102. Visible on the edible whistle component 101 is a circumferential edge portion 103 and aperture 104 that passes through the whistle component 101. The compressible body 102 includes a receptacle 200 configured to removably receive the edible whistle component 101. As will be appreciated, the compressible body 102 has a substantially hollow interior, which, when compressed, urges gas/air through the receptacle 200.

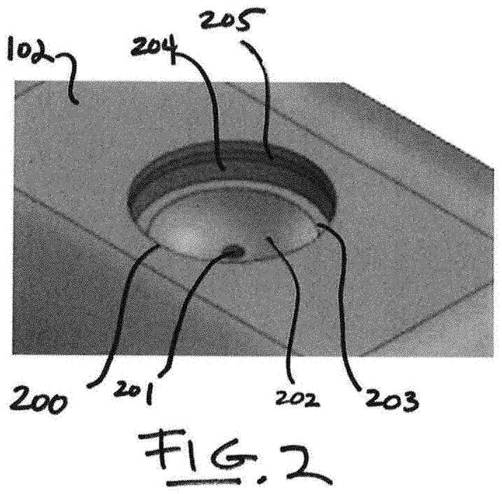

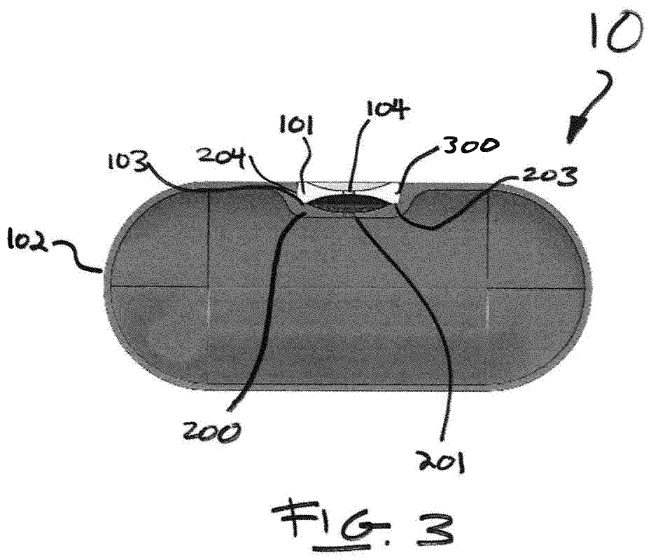

FIG. 2 illustrates a detail view of an embodiment of receptacle 200 located on the compressible body 102. As shown, the receptacle 200 contains an air/gas passage 201, situated at the apex of a concave or plano-concave bottom end 202 delimited by a shoulder portion 203. Interface walls 204 containing a groove 205 complete the structure of receptacle 200. In embodiments, the edible whistle component 101 is secured within the receptacle 200 via an interference fit, i.e., a press fit or friction fit. In certain embodiments, an edible adhesive may be employed to secure the edible whistle component 101 within the receptacle 200.

Turning now to FIG. 3, a cross-sectional view of an embodiment of the edible whistle component 101 and compressible body 102 joined together is shown. In the depicted embodiment, the edible whistle component 101 has two opposing surfaces which create a substantially bi-concave profile, which is symmetrical to or aligned with a concave or plano-concave profile of bottom end 202 of the receptacle. Also shown is the interface of circumferential edge 103 with the shoulder portion 203. A peripheral edge 300 of edible whistle component 101 is also visible and shown interacting with interface walls 204 of receptacle 200. The peripheral edge 300 contains a ridge profile which is received within the groove 205 of the receptacle 200. Aperture 104 is shown aligned with passage 201. Variant embodiments not shown may include off-axis alignment of aperture 104 and passage 201. In certain embodiments, the whistle component 101 may have a cross-sectional profile that is not bi-concave, and the bottom end 202 may have a profile that is not plano-concave.

Although the receptacle 200 and edible whistle component 101 are depicted as having a circular or disc shape, other shapes, e.g., oval, square, triangular, etc., may be utilized provided they are capable of mating together, so that the edible whistle component 101 may be removably secured within the receptacle 200. Moreover, in embodiments, the compressible body 102 may have a number of receptacles 200.

In certain embodiments, the whistle apparatus 100 may include a number of edible whistle components 101 that can be selectively placed within a receptacle to change the functionality of the apparatus. More specifically, a user may have the option of changing the sound produced by the apparatus by replacing the edible whistle component 101, with another that produces a different sound/noise. Indeed, in this manner, the apparatus 100 may be configured for a variety of pets, based on the characteristics of the noise emitted.

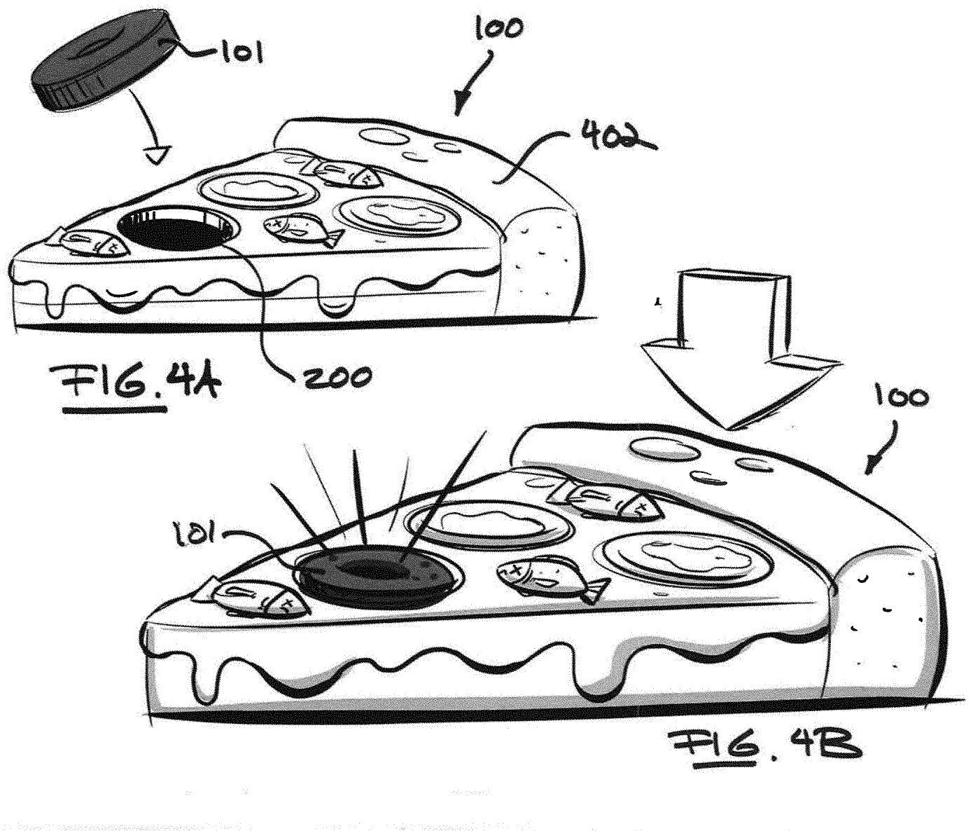

FIGS. 4A and 4B illustrate an alternative embodiment of the whistle apparatus 100 that includes a compressible body 402 in the shape of a toy, i.e., a slice of pizza, that contains receptacle 200 configured to removably receive an edible whistle component 101. FIGS. 4A and 4B also illustrate how embodiments of the present invention may be used. That is, an edible whistle component 101 may be inserted into the receptacle 300 of the body 402. Once secured within the receptacle, compression of the body 402 results in air being urged from the body and through the edible whistle component, via the aperture and passage, thereby creating an audible sound, e.g., a whistle, squeak, or other noise. As will be appreciated, if the edible whistle component 101 is removed and consumed, another component 101 may be inserted and the apparatus 100 may be re-used.

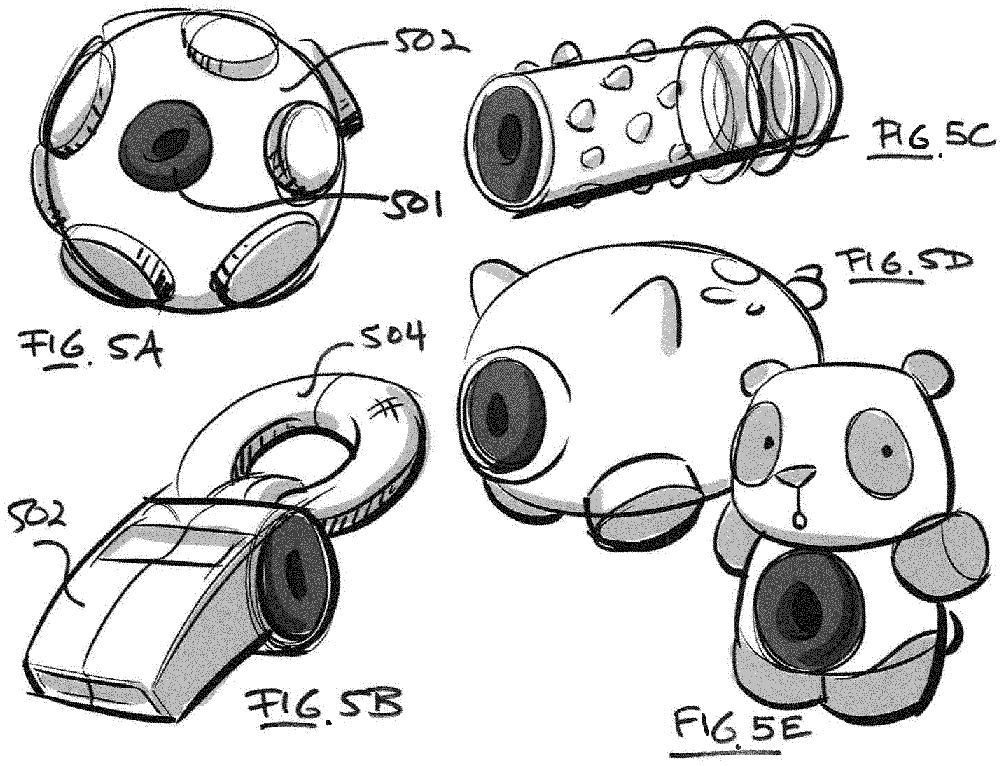

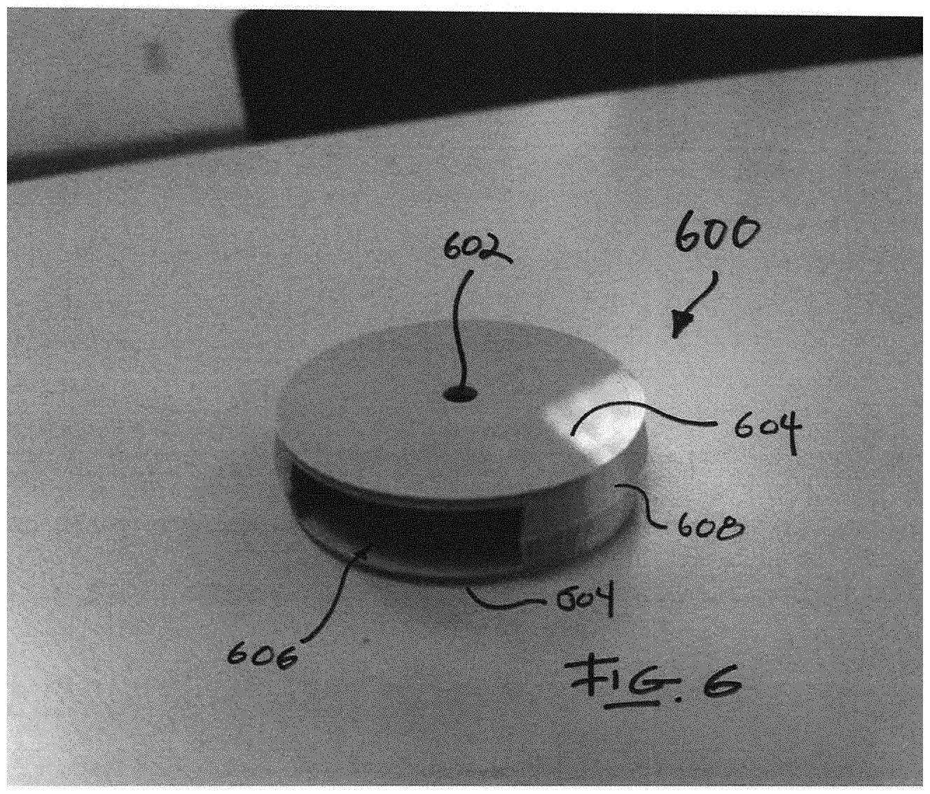

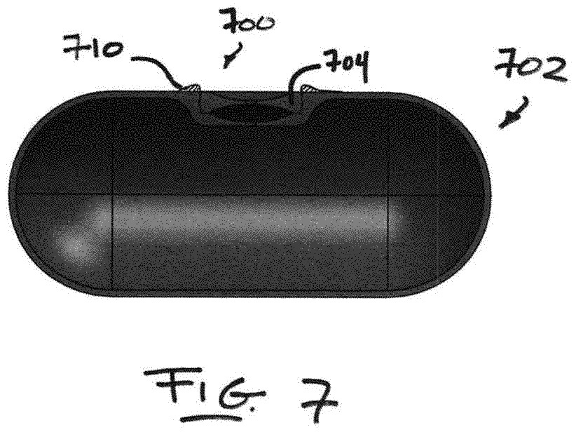

FIGS. 5A-5E illustrate multiple alternative embodiments of the present invention. Notably, the compressible body 502 may include a variety of shapes. In certain embodiments, such as that shown in FIG. 5B, the compressible body 502 may have a second body portion 504, which itself may not be compressible. As will be appreciated, the body 502 is not limited to any particular shape, size or conformation.

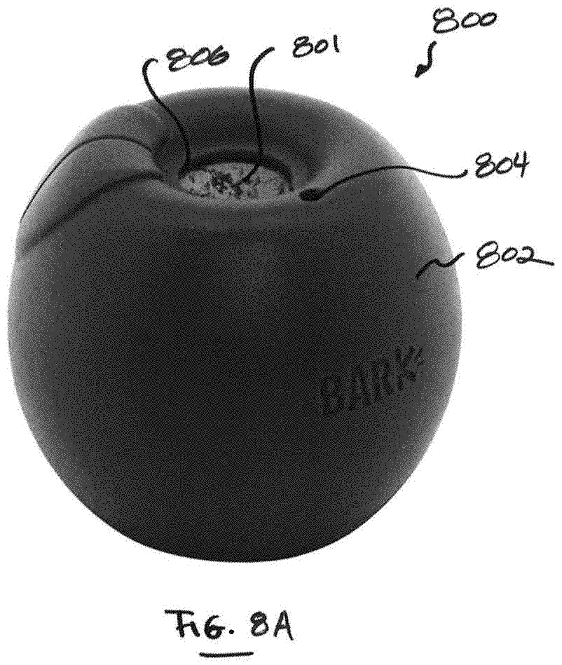

Turning now to FIG. 6, an edible whistle component 600 according to an alternative embodiment of the invention is depicted. In particular, the edible whistle component 600 may be utilized separately from a compressible body 702. The edible whistle component 600 includes a central aperture 602 and a circumferential edge portion 608 that features a cut-away portion 606 which extends into a substantially hollow interior of the whistle component 600. In use, air is urged through the central aperture 602 into the hollow interior and out the cut-away portion 606 generating audible noises/sounds. As will be appreciated, in embodiments, the whistle component 600 may be a variety of shapes and sizes, and may produce a variety of audible noises/sounds.

FIG. 7 depicts an alternative embodiment of a compressible body 702. As shown, the body 702 has a substantially hollow interior and a receptacle 700 configured to removably receive the whistle component 704. Notably, the body 702 further includes a lip or flange 710 that extends outward from and at least partially surrounds the receptacle 700 to keep the whistle component 704 removably secured therein for an extended duration. In certain embodiments, the flange 710 may entirely surround the receptacle 700. In embodiments, the flange 710 may also form a portion of, or add dimensionality to, an ornamental surface feature of the body 702.

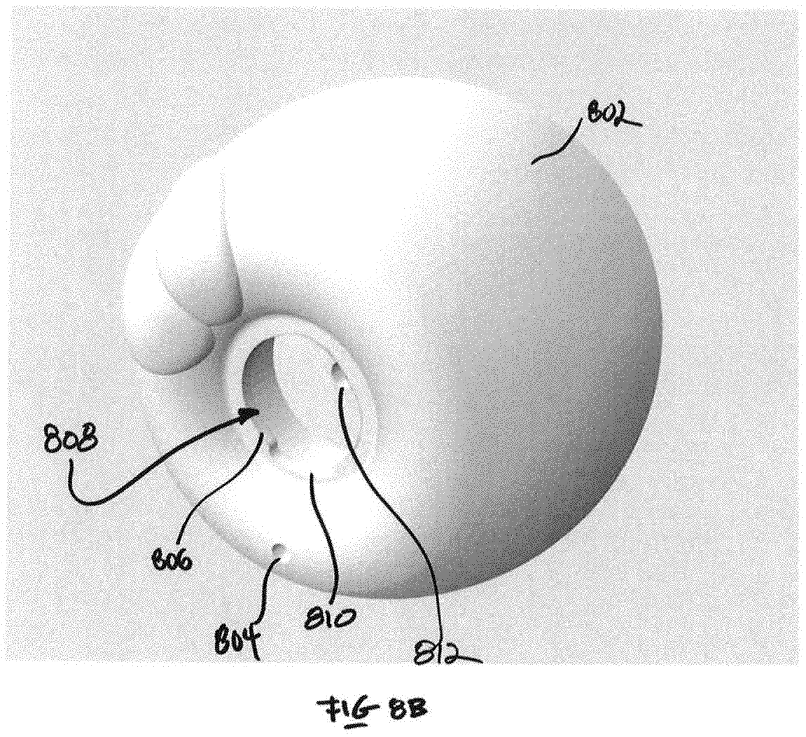

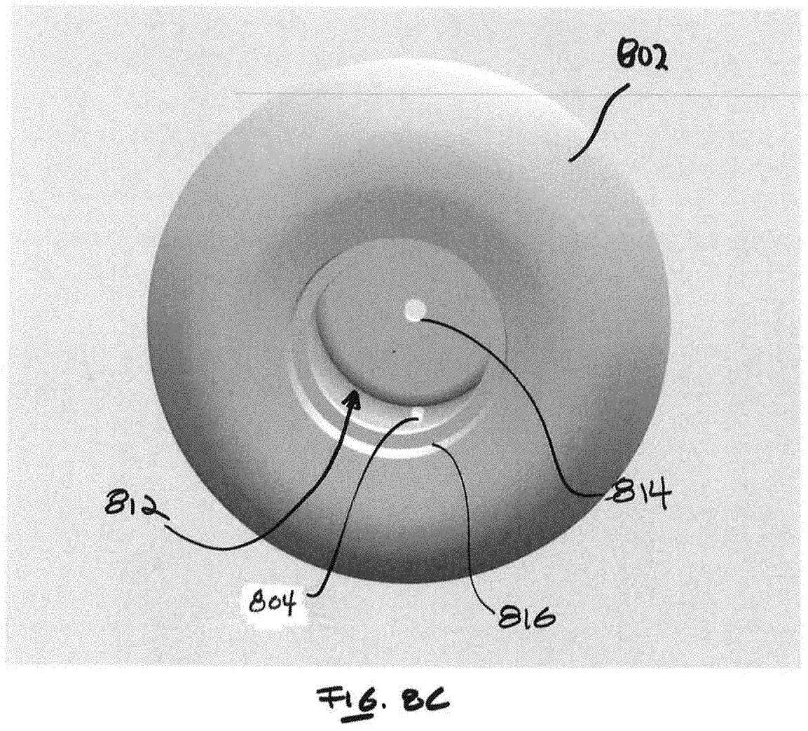

Referring now to FIGS. 8A-8C, an additional embodiment of the present invention is illustrated. As shown, the whistle apparatus 800 includes a compressible body 802 with a receptacle 808. The receptacle 808 includes a flange portion 806 that extends circumferentially around the receptacle 808. As will be appreciated, the flange portion 806 is configured to keep the whistle component 801 removably secured therein for an extended duration. To facilitate the removal or insertion of an edible whistle component from or into the receptacle 808, the flange portion 806 includes a cut-away or notched section 810. The receptacle 808 further includes a passage 814 to allow for the flow of gas, e.g., air, through an edible whistle component placed within the receptacle 808.

More specifically, as shown in FIG. 8C, which depicts a bottom surface of the compressible body 802, the passage 814 allows gas, e.g., air, to flow from a hollow interior 812 of the compressible body 802 through the passage 814 and through the aperture of the edible whistle component 810, when it is compressed. This in turn produces a sound. The hollow interior, pictured open for visualization purposes, may be closed/sealed in use, e.g., by securing material in or to the annular opening 816.

The compressible body 802 also includes a small secondary passage 804 between the hollow interior 812 and an outer surface of the body 802. The secondary passage 804 prevents undesirable suction from occurring.

Additionally, while the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, terms such as “first,” “second,” “third,” “upper,” “lower,” “bottom,” “top,” etc. are used merely as labels, and are not intended to impose numerical or positional requirements on their objects. Further, the limitations of the following claims are not written in means-plus-function format are not intended to be interpreted as such, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described invention, without departing from the spirit and scope of the invention herein involved, it is intended that all of the subject matter of the above description shown in the accompanying drawings shall be interpreted merely as examples illustrating the inventive concept herein and shall not be construed as limiting the invention.

What is claimed is:

1. A whistle apparatus comprising:
an edible whistle component having an aperture;
a compressible body containing a receptacle configured to receive the edible whistle component, the receptacle including a passage; and,
wherein when an edible whistle component is secured in the receptacle of the compressible body and the compressible body is compressed, gas is urged through both the aperture and the passage to emit a sound.

2. The whistle apparatus of claim 1 wherein the edible whistle component is secured in the receptacle via a press fit.

3. The whistle apparatus of claim 1 wherein the compressible body has a substantially hollow interior that is configured to allow gas to flow from the substantially hollow interior and through the passage and aperture when the compressible body is compressed.

4. The whistle apparatus of claim 3 wherein the substantially hollow interior further includes a secondary passage that allows gas to flow from the interior out of the compressible body to prevent undesirable suction from occurring.

5. The whistle apparatus of claim 1 wherein the compressible body has a flange that at least partially surrounds the receptacle to secure an edible whistle component therein.

6. The whistle apparatus of claim 5 wherein the flange includes a notched section to facilitate the removal or insertion of an edible whistle component from or into the receptacle.

7. The whistle apparatus of claim 1 wherein the edible whistle component has a substantially biconcave profile.

8. The whistle apparatus of claim 1 wherein the receptacle has a substantially concave profile.

9. The whistle apparatus of claim 1 wherein the passage and aperture are in substantial alignment with one another.

10. The whistle apparatus of claim 1 wherein the compressible body contains multiple receptacles each configured to receive an edible whistle component.

11. The whistle apparatus of claim 1 wherein a multiplicity of apertures and/or passages are configured in both the edible whistle component and the compressible body resulting in a plurality of emitted sounds.

12. The whistle apparatus of claim 1 wherein the apparatus further includes a second body component operatively connected to the compressible body.

13. The whistle apparatus of claim 1 wherein the edible whistle component is interchangeable among a variety of whistle apparatuses.

14. The whistle apparatus of claim 1 wherein the edible whistle component and compressible body are joined by edible glue.

15. The whistle apparatus of claim 1 wherein the frequency of the emitted sound is optimized for a target animal species.

16. A whistle apparatus comprising:
an edible whistle component having an aperture that extends therethrough;
a compressible body having a substantially hollow interior, the compressible body containing a receptacle configured to selectively receive the edible whistle component, the receptacle including a flange that at least partially surrounds the receptacle to secure the edible whistle component therein, the receptacle further including a passage into the substantially hollow interior; and
wherein when an edible whistle component is secured in the receptacle of the compressible body and the compressible body is compressed, gas is urged from the substantially hollow interior through both the aperture and the passage to emit a sound.

17. The whistle apparatus of claim 16 wherein the substantially hollow interior further includes a secondary passage that allows gas to flow from the interior out of the compressible body to prevent undesirable suction from occurring.

18. The whistle apparatus of claim 16 wherein the flange includes a notched section to facilitate the removal or insertion of the edible whistle component from or into the receptacle.

19. A edible whistle component for use in a whistle apparatus, the edible whistle component including two opposing surfaces and an aperture that extends between the surfaces; and
wherein the surfaces each have a concave profile.
